(19) United States
(12) Patent Application Publication
(10) Pub. No.: US 2014/0256909 A1
(43) Pub. Date: Sep. 11, 2014

(54) CURABLE COMPOSITIONS

(71) Applicant: Dow Global Technologies LLC, Midland, MI (US)

(72) Inventors: Maurice J. Marks, Lake Jackson, TX (US); Bindu Krishnan, Lake Jackson, TX (US); Bradley D. Seurer, Lake Jackson, TX (US); E J. Campbell, Missouri City, TX (US)

(21) Appl. No.: 14/348,207

(22) PCT Filed: Oct. 16, 2012
(86) PCT No.: PCT/US2012/060328

§ 371 Date: Mar. 28, 2014

Related U.S. Application Data
(60) Provisional application No. 61/556,979, filed on Nov. 8, 2011.

(51) Int. Cl. C08G 59/04

(52) U.S. Cl. CPC C08G 59/04
USPC 528/406

(57) ABSTRACT

A curable composition including (a) at least one divinylarene dioxide; (b) at least one polyol; and (c) at least one cure catalyst, said cure catalyst being effective in catalyzing the reaction between the divinylarene dioxide and the polyol and being active at ambient and higher temperatures, wherein the curable composition forms a compatible mixture; and cured compositions prepared from the curable composition.

### FIELD

The present invention is related to curable compositions including compatible mixtures of divinylarene dioxides, polyols and a cure catalyst; and the cured compositions resulting therefrom.

### BACKGROUND

Curable compositions containing divinylarene dioxides, polyols, and a catalyst are known in the art. However, many known compositions made from combinations of divinylarene dioxides, particularly divinylbenzene dioxide (DVBDO), polyols, and a catalyst are incompatible; and such known compositions phase separate prior to and/or during the cure of such compositions resulting in poorly cured materials. Incompatible mixtures of divinylarene dioxides, polyols, and a catalyst are opaque and have relatively high values of percent (%) opacity. Also, mixtures of divinylarene dioxides and polyols require an effective catalyst to cure at ambient or elevated temperatures and many of the known catalysts have proven ineffective.

U.S. Pat. No. 2,924,580 (“the '580 patent”) teaches various DVBDO compositions, including DVBDO with various polyols and DVBDO with various catalysts. However, the '580 patent does not teach which combinations of polyol and catalyst are compatible with DVBDO and does not teach which catalysts are effective to cure such compositions. It is difficult for the skilled artisan to predict which combinations of polyols and catalysts will be compatible with DVBDO. In fact, many of the DVBDO-polyol-catalyst mixtures taught in the '580 patent are incompatible; and many of the catalysts taught in the '580 patent are inactive in DVBDO-polyol formulations. For instance, Example 18 of the above patent is the sole DVBDO-polyol example disclosed in the '580 patent wherein triethanolamine is employed as the polyol and aqueous sulfuric acid is the catalyst; and such polyol-catalyst combination is incompatible with DVBDO.

### SUMMARY

The present invention is directed to curable compositions including a polyol-catalyst combination that is compatible with divinylarene dioxides; and to curable compositions of divinylarene dioxides, polyols, and a cure catalyst that have low % opacity values. The curable compositions include effective ambient and thermally-active curing catalysts such as catalysts selected from Bronsted and Lewis acids and metal compounds.

One of the advantages of the present invention over the prior art is the use of compatible mixtures of divinylarene dioxides, polyols, and a cure catalyst to avoid phase separation before or during cure, and the use of catalysts which are effective in catalyzing the reaction between the divinylarene dioxides and polyols and which are active at ambient temperature (from about −20° C. to about 40° C., most typically about 25° C.) or higher temperatures. It is well known in the art that phase separation of co-reactive monomers and/or the use of ineffective catalysts do not provide cured materials having useful properties.

One embodiment of the present invention is directed to a curable composition of matter including (a) a divinylarene dioxide; (b) at least one polyol; and (c) at least one cure catalyst, said catalyst being effective in catalyzing the reaction between the divinylarene dioxide and the polyol and being active at ambient and higher temperatures, wherein the composition forms a compatible mixture. Other optional materials such as optional curing agents, optional fillers, optional reactive diluents, optional flexibilizing agents, optional processing aides, and optional toughening agents can be used in the curable composition of the present invention in other embodiments.

In one embodiment, the curable composition of the present invention is formulated to have a low % opacity value of less than about 90; and the composition is formulated to operate at an ambient temperature and greater such that the curing catalyst used in the composition provides a cured composition in less than 24 hours and at a cure temperature of about −50° C. to about 200° C.

### DETAILED DESCRIPTION

A “compatible mixture” herein means a mixture of divinylarene dioxide, polyol, and catalyst which has a % opacity less than about 90. Such compatible mixtures are not grossly phase separated and thereby can cure to form homogeneous cured materials having uniform properties. Conversely, incompatible mixtures are grossly phase separated and thereby cure to form heterogeneous cured (or, more commonly, only partially cured) materials having properties which vary widely by location in the material.

In its broadest scope, the present invention includes a curable composition comprising a mixture of (a) at least one divinylarene dioxide; (b) at least one polyol; and (c) a catalyst such as for example a catalyst selected from a Bronsted or a Lewis acid, a main group or transition metal complex, or an imidazolium salt, such that the mixture of the divinylarene dioxide, polyol, and catalyst has a % opacity of less than about 90. The curable composition of the present invention described above can be cured to form a cured composition or thermoset by exposing the curable composition to either ambient or elevated temperatures.

In one embodiment, the divinylarene dioxide, component (a), useful in preparing the curable composition of the present invention may comprise, for example, any substituted or unsubstituted arene nucleus bearing one or more vinyl groups in any ring position. For example, the arene portion of the divinylarene dioxide may consist of benzene, substituted benzenes, (substituted) ring-annulated benzenes or homologously bonded (substituted) benzenes, or mixtures thereof. The divinylbenzene portion of the divinylarene dioxide may be ortho, meta, or para isomers or any mixture thereof. Additional substituents may consist of H₂O₂-resistant groups including saturated alkyl, aryl, halogen, nitro, isocyanate, or RO—(where R may be a saturated alkyl or aryl). Ring-annulated benzenes may consist of naphthlalene, and tetrahydronaphthalene. Homologously bonded (substituted) benzenes may consist of biphenyl, and diphenylether.

The divinylarene dioxide used for preparing the formulations of the present invention may be illustrated by general chemical Structures I-IV as follows:

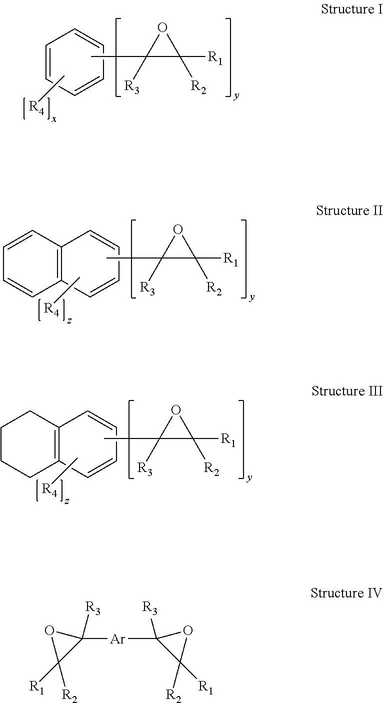

In the above Structures I, II, III, and IV of the divinylarene dioxide comonomer of the present invention, each R₁, R₂, R₃ and R₄ individually may be hydrogen, an alkyl, cycloalkyl, an aryl or an aralkyl group; or a H₂O₂-resistant group including for example a halogen, a nitro, an isocyanate, or an RO group, wherein R may be an alkyl, aryl or aralkyl; x may be an integer of 0 to 4; y may be an integer greater than or equal to 2; x+y may be an integer less than or equal to 6; z may be an integer of 0 to 6; and z+y may be an integer less than or equal to 8; and Ar is an arene fragment including for example, 1,3-phenylene group. In addition, R₄ can be a reactive group(s) including epoxide, isocyanate, or any reactive group and Z can be an integer from 0 to 6 depending on the substitution pattern.

In one embodiment, the divinylarene dioxide used in the present invention may be produced, for example, by the process described in U.S. Patent Provisional Application Ser. No. 61/141,457, filed Dec. 30, 2008, by Marks et al., incorporated herein by reference. The divinylarene dioxide compositions that are useful in the present invention are also disclosed in, for example, U.S. Pat. No. 2,924,580, incorporated herein by reference.

In another embodiment, the divinylarene dioxide useful in the present invention may comprise, for example, divinylbenzene dioxide, divinylnaphthalene dioxide, divinylbiphenyl dioxide, divinyldiphenylether dioxide, and mixtures thereof.

In one preferred embodiment of the present invention, the divinylarene dioxide used in the formulation of the present invention may be for example divinylbenzene dioxide (DVBDO). In another preferred embodiment, the divinylarene dioxide component that is useful in the present invention includes, for example, a DVBDO as illustrated by the following chemical formula of Structure V:

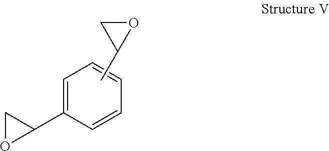

The chemical formula of the above DVBDO compound may be as follows: C₁₀H₁₀O₂; the molecular weight of the DVBDO is about 162.2; and the elemental analysis of the DVBDO is about: C, 74.06; H, 6.21; and 0, 19.73 with an epoxide equivalent weight of about 81 g/mol.

Divinylarene dioxides, particularly those derived from divinylbenzene such as for example DVBDO, are class of diepoxides which have a relatively low liquid viscosity but a higher rigidity and crosslink density than conventional epoxy resins.

Structure VI below illustrates one preferred embodiment of a chemical structure of the DVBDO useful in the present invention:

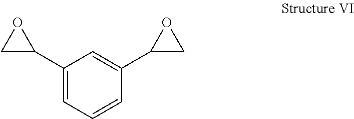 [SMILES: c1cc(C2CO2)cc(C2CO2)c1]

Structure VII below illustrates another preferred embodiment of a chemical structure of the DVBDO useful in the present invention:

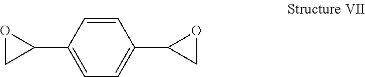 [SMILES: c1cc(C2CO2)ccc1C1CO1]

When DVBDO is prepared by the processes known in the art, it is possible to obtain one of three possible isomers: ortho, meta, and para. Accordingly, the present invention includes a DVBDO illustrated by any one of the above Structures individually or as a mixture thereof. Structures VI and VII above show the meta (1,3-DVBDO) isomer and the para (1,4-DVBDO) isomer of DVBDO, respectively. The ortho isomer is rare; and usually DVBDO is mostly produced generally in a range of from about 9:1 to about 1:9 ratio of meta (Structure VI) to para (Structure VII) isomers in one embodiment; from about 6:1 to about 1:6 ratio of Structure VI to Structure VII in another embodiment, from about 4:1 to about 1:4 ratio of Structure VI to Structure VII in still another embodiment, and from about 2:1 to about 1:2 ratio of Structure VI to Structure VII in yet another embodiment.

In yet another embodiment of the present invention, the divinylarene dioxide may contain quantities (such as for example less than about 20 weight percent) of substituted arenes. The amount and structure of the substituted arenes depend on the process used in the preparation of the divinylarene precursor to the divinylarene dioxide. For example, divinylbenzene prepared by the dehydrogenation of diethylbenzene (DEB) may contain quantities of ethylvinylbenzene (EVB) and DEB. Upon reaction with hydrogen peroxide, EVB produces ethylvinylbenzene monoxide while DEB remains unchanged. The presence of these compounds can increase the epoxide equivalent weight of the divinylarene dioxide to a value greater than that of the pure compound but can be utilized at levels of 0 to 99% of the epoxy resin portion.

In one embodiment, the divinylarene dioxide, for example DVBDO, useful in the present invention comprises a low viscosity liquid epoxy resin. For example, the viscosity of the divinylarene dioxide used in the present invention ranges generally from about 0.001 Pa s to about 0.1 Pa s in one embodiment, from about 0.01 Pa s to about 0.05 Pa s in another embodiment, and from about 0.01 Pa s to about 0.025 Pa s in still another embodiment, at 25° C.

The concentration of the divinylarene oxide used in the present invention as the epoxy resin portion of the adduct reaction product composition may range generally from about 0.5 weight percent (wt %) to about 100 wt % in one embodiment, from about 1 wt % to about 99 wt % in another embodiment, from about 2 wt % to about 98 wt % in still another embodiment, and from about 5 wt % to about 95 wt % in yet another embodiment, depending on the fractions of the other ingredients in the reaction product composition.

One advantageous property of the divinylarene dioxide useful in the present invention is its rigidity. The rigidity property of the divinylarene dioxide is measured by a calculated number of rotational degrees of freedom of the dioxide excluding side chains using the method of Bicerano described in Prediction of Polymer Properties, Dekker, New York, 1993. The rigidity of the divinylarene dioxide used in the present invention may range generally from about 6 to about 10 rotational degrees of freedom in one embodiment, from about 6 to about 9 rotational degrees of freedom in another embodiment, and from about 6 to about 8 rotational degrees of freedom in still another embodiment.

In one embodiment of the system of the present invention, DVBDO is the epoxy resin component, used in a concentration of about 20 wt % to 80 wt % based on the weight of the total reaction product composition.

The polyol, component (b), useful for the curable composition of the present invention, may comprise any conventional polyol known in the art and particularly any compound or mixtures of compounds containing two or more hydroxyl groups. For example, the polyol useful in the curable composition, may be selected from, but are not limited to, diols, glycols, triols, tetrols, pentols, hexyls, and mixtures thereof.

In one preferred embodiment, the polyol may include for example alkyl and alkyl ether polyols, polymeric polyols such as polyether polyols, polyester polyols (including polycaprolactone polyols), polycarbonate polyols, and polyalkylidine polyols, and mixtures thereof.

Generally, the amount of polyol used is at stoichiometric balance, or more so, or less so, based on equivalents compared to that of the epoxide groups. For example, generally the equivalent ratio r of epoxide to hydroxyl can be from about 0.1 to about 100 in one embodiment, from about 0.5 to 50 in another embodiment, and from about 1 to about 10 in still another embodiment.

In preparing the curable resin formulation of the present invention, at least one cure catalyst must be used to facilitate the reaction of the divinylarene dioxide compound with the polyol. In addition to being effective in catalyzing the reaction between the divinylarene dioxide and the polyol, the catalyst is preferably active at ambient (about 25° C.) and at higher temperatures, e.g. up to 200° C. For example, the cure catalyst can be active at a temperature range of −50° C. to 200° C.

The catalyst useful in the present invention may include, for example, any Bronsted or Lewis acid, a main group or transition metal complex, an imidazolium salt, or mixtures thereof, which cure mixtures of divinylarene dioxide and polyol at a temperature from −50° C. to 200° C. within 24 hours.

The catalyst, component (c), useful in the present invention may include Bronsted acid catalysts known in the art, such as for example, sulfuric acid, phosphoric acid, a substituted or unsubstituted benzenesulfonic acid, and any combination thereof.

The catalyst, component (c), useful in the present invention may also include Lewis acid catalysts known in the art, such as for example, aluminum chloride, aluminum sulfate, aluminum nitrate, aluminum t-butoxide-hydrogen chloride complex, aluminum t-butoxide-acetic acid complex, copper (II) tetrafluoroborate, iron (III) chloride, tin (II) chloride, tin (IV) chloride, antimony bromide, antimony acetate, antimony hexafluorosulfide, and any combination thereof.

The catalyst, component (c), useful in the present invention may further include main group or transition metal complex catalysts well known in the art of curing polyurethanes, such as for example, dimethyltin neodecanoate, stannous octoate, molybdenum (II) dicarboxylates, titanium-amine complexes, zinc complexes, and any combination thereof.

The catalyst, component (c), useful in the present invention may still further include imidazolium salts well known in the art, such as for example, 1-ethyl-3-methylimidazolium tetrafluoroborate, 1-ethyl-3-methylimidazolium trifluoromethanesulfonate, 1-methyl-3-n-octylimidazolium tetrafluoroborate, 1-methyl-3-n-propylimidazolium iodide, 1-n-butyl-2,3-dimethylimidazolium tetrafluoroborate, 1-n-butyl-3-methylimidazolium bis(trifluoromethylsulfonyl)imide, 1-n-butyl-3-methylimidazolium bromide, 1-n-butyl-3-methylimidazolium chloride, 1-n-butyl-3-methylimidazolium hexafluoroantimonate, 1-n-butyl-3-methylimidazolium hexafluorophosphate, 1-n-butyl-3-methylimidazolium methanesulfonate, 1-n-butyl-3-methylimidazolium methylsulfate, 1-n-butyl-3-methylimidazolium n-octylsulfate, 1-n-butyl-3-methylimidazolium tetrafluoroborate, 1-n-butyl-3-methylimidazolium trifluoromethanesulfonate, 1-n-hexyl-3-methylimidazolium chloride, 1-n-hexyl-3-methylimidazolium hexafluorophosphate, 1-n-hexyl-3-methylimidazolium tetrafluoroborate, 1,3,-bis(2,6-diisopropylphenyl) imidazolium chloride, 1,3-diisopropylimidazolium chloride, 1,3-dimesitylimidazolium chloride, 1,3-dimethylimidazolium dimethylphosphate, 1-allyl-3-methylimidazolium chloride, 1-butyl-2,3-dimethylimidazolium chloride, 1-butyl-2,3-dimethylimidazolium hexafluorophosphate, 1-ethyl-3-methylimidazolium bis(trifluoromethylsulfonyl)imide, 1-ethyl-3-methylimidazolium bromide, 1-ethyl-3-methylimidazolium chloride, 1-ethyl-3-methylimidazolium dicyanamide, 1-ethyl-3-methylimidazolium diethylphosphate, 1-ethyl-3-methylimidazolium ethylsulfate, 1-ethyl-3-methylimidazolium hexafluorophosphate, 1-ethyl-3-methylimidazolium hydrogen sulfate, 1-ethyl-3-methylimidazolium methanesulfonate, and any combination thereof.

In a preferred embodiment, the cure catalysts useful in the present invention may include dodecylbenzenesulfonic acid, antimony bromide, antimony acetate, stannous chloride, stannic chloride, phosphoric acid, iron chloride, antimony hexafluorosulfide, aluminum chloride, aluminum t-butoxide-hydrogen chloride complex, aluminum t-butoxide-acetic acid complex, aluminum nitrate, aluminum sulfate, dimethyltin neodecanoate, stannous octoate, molybdenum octoate, titanium-amine complexes, zinc complexes, 1-ethyl-3-methylimidazolium acetate, and mixtures thereof.

The concentration of the cure catalyst used in the present invention may range generally from about 0.01 wt % to about 20 wt % in one embodiment, from about 0.1 wt % to about 10 wt % in another embodiment, from about 1 wt % to about 10 wt % in still another embodiment, and from about 2 wt % to about 10 wt % in yet another embodiment.

Optional compounds that may be added to the curable composition of the present invention may include, for example, other epoxy resins different from the divinylarene dioxide (e.g., aromatic and aliphatic glycidyl ethers, cycloaliphatic epoxy resins). For example, the epoxy resin which is different from the divinylarene dioxide may be any epoxy resin component or combination of two or more epoxy resins known in the art such as epoxy resins described in Lee, H. and Neville, K., Handbook of Epoxy Resins, McGraw-Hill Book Company, New York, 1967, Chapter 2, pages 2-1 to 2-27, incorporated herein by reference.

Suitable other epoxy resins known in the art include for example epoxy resins based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known in the art include for example reaction products of epichlorohydrin with o-cresol novolacs, hydrocarbon novolacs, and, phenol novolacs. The epoxy resin may also be selected from commercially available products such as for example, D.E.R. 331®, D.E.R.332, D.E.R. 354, D.E.R. 580, D.E.N. 425, D.E.N. 431, D.E.N. 438, D.E.R. 736, or D.E.R. 732 epoxy resins available from The Dow Chemical Company.

Generally, the amount of other epoxy resin, when used in the present invention, may be for example, from about 0 equivalent % to about 99 equivalent % in one embodiment, from about 0.1 equivalent % to about 95 equivalent % in another embodiment; from about 1 equivalent % to about 90 equivalent % in still another embodiment; and from about 5 equivalent % to about 80 equivalent % of the total epoxides in yet another embodiment.

Another optional compound useful for the curable composition of the present invention may comprise any conventional curing agent known in the art. The curing agent, (also referred to as a hardener or cross-linking agent) useful in the curable composition, may be selected, for example, from those curing agents well known in the art including, but are not limited to, anhydrides, carboxylic acids, amine compounds, phenolic compounds, polymercaptans, or mixtures thereof.

Examples of optional curing agents useful in the present invention may include any of the co-reactive or catalytic curing materials known to be useful for curing epoxy resin based compositions. Such co-reactive curing agents include, for example, polyamine, polyamide, polyaminoamide, dicyandiamide, polymeric thiol, polycarboxylic acid and anhydride, and any combination thereof or the like. Suitable catalytic curing agents include tertiary amine, quaternary ammonium halide, Lewis acids such as boron trifluoride, and any combination thereof or the like. Other specific examples of co-reactive curing agent include diaminodiphenylsulfone, styrene-maleic acid anhydride (SMA) copolymers; and any combination thereof. Among the conventional co-reactive epoxy curing agents, amines and amino or amido containing resins and phenolics are preferred. Still another class of optional curing agents useful in the compositions of the present invention include anhydrides and mixtures of anhydrides with other curing agents.

Generally, the amount of optional curing agent, when used in the present invention, may be for example, from 0 equivalent % to about 99 equivalent % in one embodiment, from about 0.1 equivalent % to about 90 equivalent % in another embodiment; from about 1 equivalent % to about 75 equivalent % in still another embodiment; and from about 5 equivalent % to about 50 equivalent % of the total curing agent functional groups (polyol and optional curing agent) in yet another embodiment.

Other optional components that may be useful in the present invention are components normally used in resin formulations known to those skilled in the art. For example, the optional components may comprise compounds that can be added to the composition to enhance application properties (e.g. surface tension modifiers or flow aids), reliability properties (e.g. adhesion promoters), and/or the catalyst lifetime.

An assortment of other additives may be added to the compositions or formulations of the present invention including for example, other curing agents, fillers, pigments, toughening agents, flow modifiers, other resins different from the epoxy resins and the divinylarene dioxide, diluents, stabilizers, fillers, plasticizers, catalyst de-activators, a halogen containing or halogen free flame retardant; a solvent for processability including for example acetone, methyl ethyl ketone, an Dowanol PMA; adhesion promoters such as modified organosilanes (epoxidized, methacryl, amino), acytlacetonates, or sulfur containing molecules; wetting and dispersing aids such as modified organosilanes; a reactive or non-reactive thermoplastic resin such as polyphenylsulfones, polysulfones, polyethersolufones, polyvinylidene fluoride, polyetherimide, polypthalimide, polybenzimidiazole, acrylics, phenoxy, urethane; a mold release agent such as waxes; other functional additives or pre-reacted products to improve polymer properties such as isocyanates, isocyanurates, cyanate esters, allyl containing molecules or other ethylenically unsaturated compounds, and acrylates; and mixtures thereof.

The concentration of the optional additives useful in the present invention may range generally from 0 wt % to about 90 wt % in one embodiment, from about 0.01 wt % to about 80 wt % in another embodiment, from about 0.1 wt % to about 65 wt % in still another embodiment, and from about 0.5 wt % to about 50 wt % in yet another embodiment.

The process for preparing an epoxy formulation or composition includes blending (a) at least one divinylarene dioxide; (b) at least one polyol; (c) at least one cure catalyst; and (d) optionally, other ingredients as needed. For example, the preparation of the curable epoxy resin formulation of the present invention is achieved by blending with or without vacuum in a Ross PD Mixer (Charles Ross), a divinylarene dioxide, a polyol, a cure catalyst, and optionally any other desirable additives. Any of the above-mentioned optional assorted formulation additives, for example an additional epoxy resin, may also be added to the composition during the mixing or prior to the mixing to form the composition.

In one embodiment, the process for preparing the composition of the present invention comprises (a) combining a polyol and catalyst to form a polyol-catalyst mixture (solution or suspension), then (b) combining the polyol-catalyst mixture and a divinylarene dioxide to form a compatible mixture.

All the components of the epoxy resin formulation are typically mixed and dispersed at a temperature enabling the preparation of an effective epoxy resin composition having the desired balance of properties for a particular application. For example, the temperature during the mixing of all components may be generally from about −10° C. to about 100° C. in one embodiment, and from about 0° C. to about 50° C. in another embodiment. Lower mixing temperatures help to minimize reaction of the resin and polyol components to maximize the pot life of the formulation.

The blended compound is typically stored at sub-ambient temperatures to maximize shelf life. Acceptable temperature ranges are for example from about −100° C. to about 25° C. in one embodiment, from about −70° C. to about 10° C. in another embodiment, and from about −50° C. to about 0° C. in still another embodiment. As an illustration of one embodiment, the temperature at which the blended formulation is stored may be about −40° C.

The blended formulation can then be applied via a number of methods depending on the application. For example, typical application methods include casting, injection molding, extrusion, rolling, and spraying.

The curable composition of the present invention comprises a combination of a divinylarene dioxide, a polyol, and a curing catalyst; wherein the curable composition has a % opacity, prior to addition of any optional component or components, of less than 90 in one embodiment, from 0 to 80 in another embodiment, and from about 0 to about 70 in still another embodiment.

The curable composition advantageously cures at a temperature of between −50° C. and 200° C. in one embodiment, from −10 to 175° C. in another embodiment, and from about 0 to about 150° C. in still another embodiment.

The curing time period of the curable composition is beneficially within 24 hours in one embodiment, from about 0.1 hour to 24 hours in another embodiment, and from about 0.2 hour to about 12 hours in still another embodiment.

The curing of the curable composition may be carried out at a predetermined temperature and for a predetermined period of time sufficient to cure the composition and the curing may be dependent on the hardeners used in the formulation. For example, the temperature of curing the formulation may be generally from about −50° C. to about 200° C. in one embodiment; from about −10° C. to about 175° C. in another embodiment; and from about 0° C. to about 150° C. in still another embodiment; and generally the curing time may be chosen between about 1 minute to about 24 hours in one embodiment, between about 5 minutes to about 12 hours in another embodiment, and between about 10 minutes to about 6 hours in still another embodiment. Below a period of time of about 1 minute, the time may be too short to ensure sufficient reaction under conventional processing conditions; and above about 24 hours, the time may be too long to be practical or economical.

The divinylarene dioxide of the present invention such as divinylbenzene dioxide (DVBDO), which is the epoxy resin component of the curable composition of the present invention, may be used as the sole resin to form the epoxy matrix in the final formulation; or the divinylarene dioxide resin may be used in combination with another epoxy resin that is different from the divinylarene dioxide as the epoxy component in the final formulation. For example the different epoxy resin may be used as an additive diluent.

In one embodiment, the use of divinylbenzene dioxide such as DVBDO imparts improved properties to the curable composition and the final cured product over conventional glycidyl ether, glycidyl ester or glycidyl amine epoxy resins. The DVBDO's unique combination of low viscosity in the uncured state, and high Tg after cure due to the rigid DVBDO molecular structure and increase in cross-linking density enables a formulator to apply new formulation strategies. In addition, the ability to cure the epoxy resin with an expanded hardener range, offers the formulator significantly improved formulation latitude over other types of epoxy resins such as epoxy resins of the cycloaliphatic type resins (e.g., ERL-4221, formerly from The Dow Chemical Company).

As is well known in the art, curable compositions are converted upon curing from a liquid, paste, or powder formulation into a durable solid cured composition. The resulting cured composition of the present invention displays such excellent properties, such as, for example, surface hardness. The properties of the cured compositions of the present invention may depend on the nature of the components of the curable formulation. In one preferred embodiment, the cured compositions of the present invention exhibit a Shore A hardness value of from about 5 to about 100, from about 10 to about 100 in another embodiment, and from about 20 to about 100 in yet another embodiment. In another preferred embodiment, the cured compositions of the present invention exhibit a Shore D hardness value of from about 5 to about 100, from about 10 to about 100 in another embodiment, and from about 20 to about 100 in yet another embodiment.

The curable composition of the present invention may be used to manufacture coatings, films, adhesives, binders, sealants, laminates, composites, electronics, and castings.

### EXAMPLES

The following examples and comparative examples further illustrate the present invention in detail but are not to be construed to limit the scope thereof.

Various terms and designations used in the following examples are explained herein below:

“DVBDO” stands for divinylbenzene dioxide. WO2010077483 describes one of range of methods of preparing DVBDO.

“BDO” stands for 1,4-butanediol.

“Room temperature” is about 20° C. to 25° C.

CAPA 3031 is a polycaprolactone triol from Perstorp Corp. having a hydroxyl equivalent weight (HEW) of 100 g/eq.

Terathane 250, 650, and 1000 are polytetramethylene polyols from Invista having HEW of 125, 325, and 500 g/eq., respectively.

Voranol 225 is a poly(propylene oxide) polyol from The Dow Chemical Company having a HEW=83 g/eq.

Tone 0301, 0305, and 0310 are polycaprolactone triols from The Dow Chemical Company having HEW of 100, 180, and 300 g/eq., respectively.

PCPO 1000 and 2000 are hexanediol polycarbonate diols from The Dow Chemical Company having HEW of 500 and 1000 g/eq., respectively.

Fomrez 44-160, 55-225, and 55-112 are polyester polyols from Chemtura, Inc. having HEW of 350, 250, and 500 g/eq., respectively.

DMP-30 is 2,4,6-tris(dimethylaminomethyl)phenol (Ancamine K54 from Air Products).

Cycat 600 is dodecylbenzenesulfonic acid, 70 wt % in isopropanol from Cytec, Inc.

K-KAT XK-614 is a proprietary zinc complex from King Industries, Inc.

UL-28 is dimethyltin neodecanoate from Momentive, Inc.

Snapcure 2130 is a proprietary titanium complex from Johnson Matthey.

EMA is 1-ethyl-3-methylimidazolium acetate.

The following standard analytical equipments and methods are used in the Examples:

The percent (%) opacity of the mixtures is determined using a Hunter lab Color Quest XT optical analysis instrument at room temperature (20° C.-25° C.).

Glass transition temperature (Tg) is determined by differential scanning calorimetry (DSC) using a TA Instruments Q200 calorimeter operated using a temperature sweep at 10° C./minute.

Shore hardness is determined using ASTM D2240 using a Type A durometer from PTC Instruments or a Type D durometer from Shore-Instron Inc.

### Examples 1-6 and Comparative Examples A-G

### Compatibility of DVBDO, Polyols, and Catalysts

DVBDO and the polyols listed in Table I were mixed using amounts giving equivalent epoxide and hydroxyl content (r=1) at room temperature (20° C.-25° C.). Samples were well mixed and analyses were done prior to phase separation of the incompatible mixtures. Mixture incompatibility is indicated by an opacity >90%. Examples 1-6 were optically colorless and transparent but Comparative Examples A-E were white and opaque.

TABLE I
Compatibility of DVBDO and Selected Polyols With and Without Catalyst.

| | | DVBDO | Polyol | Polyol | Catalyst | Catalyst | Opacity |
|---|---|---|---|---|---|---|---|
| Example | r | (g) | Type | (g) | Type | (g) | (%) |
| Comparative A | 1.0 | 32.0 | 1,2-propylene glycol | 15.0 | none | | 100 |
| Example 1 | 1.0 | 32.0 | 1,2-propylene glycol | 15.0 | Cycat 600 | 0.051 | 5 |
| Comparative B | 1.6 | 32.0 | 1,2-propylene glycol | 9.4 | none | | 100 |
| Example 2 | 1.6 | 32.0 | 1,2-propylene glycol | 9.4 | Cycat 600 | 0.039 | 3 |
| Comparative C | 2.0 | 34.0 | triethanolamine | 14.1 | none | | 2 |
| Comparative D | 2.0 | 34.0 | triethanolamine | 14.1 | 5% aq. H2SO4 | 0.900 | 100 |
| Example 3 | 2.0 | 34.0 | triethanolamine | 14.1 | Cycat 600 | 0.045 | 2 |
| Comparative E | 1.0 | 32.2 | glycerol | 12.3 | none | | 99 |
| Example 4 | 1.0 | 35.1 | glycerol | 13.3 | Cycat 600 | 0.051 | 100 |
| Comparative F | 1.0 | 32.2 | ethylene glycol | 12.4 | none | | 99 |
| Example 5 | 1.0 | 36.0 | ethylene glycol | 12.9 | Cycat 600 | 0.049 | 100 |
| Comparative G | 1.0 | 32.5 | 1,4-butanediol | 18.1 | none | | 99 |
| Example 6 | 1.0 | 32.0 | 1,4-butanediol | 17.8 | Cycat 600 | 0.048 | 100 |

The examples in Table I above show that (1) incompatible DVBDO-polyol mixtures in various stoichiometric ratios can be rendered compatible by the presence of a selected catalyst, and (2) compatible DVBDO-polyol mixtures can be rendered incompatible by the presence of a selected catalyst but remain compatible in the presence of another selected catalyst. Comparative Example D is equivalent to Example 18 described in U.S. Pat. No. 2,924,580.

### Example 7 and Comparative Examples H-J

### Activity of Catalysts in the Thermal Cure of DVBDO and Voranol 225 Polyol

To a 20 mL vial were added 2.00 g DVBDO and 2.05 g Voranol 225 (epoxide/hydroxyl equivalent ratio r=1.0) and mixed to form a colorless solution. Then 0.05 g of the compound indicated in Table II was added, the contents mixed, and then poured into a 5.1 cm aluminum (Al) dish. The formulations were heated to 100° C. in an air-recirculating oven and held for 30 minutes (min). The results show that compatible mixtures of DVBDO and a polyol cure only in the presence of selected catalysts.

TABLE II
Activity of Catalysts in Thermal Cure of DVBDO and Voranol 225 Polyol

| | | Tg | Shore A | Shore D |
|---|---|---|---|---|
| Example | Compound Added | (° C.) | Hardness | Hardness |
| Comparative H | none | liquid | not cured | not cured |
| Comparative I | benzyldimethylamine | liquid | not cured | not cured |
| Comparative J | DMP-30 | liquid | not cured | not cured |
| Example 7 | Cycat 600 | 24 | 73 | 33 |

### Examples 8-10

### Thermal Cure of DVBDO and Voranol 225 Polyol with Increasing Excess Epoxide

The procedure of Example 7 was repeated using Cycat 600 as catalyst and greater amounts of DVBDO to increase the value of r. These formulations were cured for 1 hour (hr) at 100° C. to give tack-free solids having properties shown in Table III. The results for Example 7 are added for comparison and show increasing cured Tg and hardness with increasing amounts of excess epoxide.

TABLE III
Thermal Cure of DVBDO and Voranol 225 Polyol with
Increasing Excess Epoxide

| | | Tg | Shore A | Shore D |
|---|---|---|---|---|
| Example | r | (° C.) | Hardness | Hardness |
| Example 7 | 1.0 | 24 | 73 | 33 |
| Example 8 | 1.1 | 34 | 85 | 53 |
| Example 9 | 1.2 | 41 | 95 | 63 |
| Example 10 | 1.4 | 45 | 95 | 74 |

### Examples 11-14

### Thermal Cure of DVBDO and Various Diols with Cycat 600 Catalyst

The procedure of Example 7 was repeated using 0.05 mL Cycat 600 as catalyst, DVBDO, and various diols at r=1.6. The formulation components for Examples 11, 13, and 14 were mixed at room temperature to give colorless solutions. In Example 12 the DVBDO and diol were mixed at about 60° C. to form a colorless solution, to which after cooling to about 30° C. the catalyst was added. The formulations were cured for 1 hr each at 60° C. and 100° C. to give tack-free solids having properties shown in Table IV.

TABLE IV
Thermal Cure of DVBDO and Various Diols with Cycat 600 Catalyst

| | | DVBDO | Diol | Tg | Shore D |
|---|---|---|---|---|---|
| Example | Diol | (g) | (g) | (° C.) | Hardness |
| Example 11 | 1,2-propylene glycol | 4.02 | 1.16 | 110 | 85 |
| Example 12 | neopentyl glycol | 3.99 | 1.59 | 86 | 80 |
| Example 13 | 1,2-butanediol | 4.00 | 1.38 | 54 | 91 |
| Example 14 | bisphenol A ethoxylate | 2.01 | 3.80 | 21 | 60 |

### Examples 15-17

### Thermal Cure of DVBDO and Tone Polycaprolactone Triols with Cycat 600 Catalyst

The procedure of Example 7 was repeated using 0.05 mL Cycat 600 as catalyst, DVBDO, and various Tone polycaprolactone polyols at r=1.6. The polyols were heated to about 60° C. to melt and/or reduce viscosity prior to combining with DVBDO. The formulation components were mixed at room temperature to give colorless solutions. The formulations were cured for 2 hr 100° C. to give tack-free solids having properties shown in Table V.

TABLE V
Thermal Cure of DVBDO and Tone
Polycaprolactone Triols with Cycat 600 Catalyst

| | Tone | DVBDO | Polyol | Tg | Shore D |
|---|---|---|---|---|---|
| Example | Polyol | (g) | (g) | (° C.) | Hardness |
| Example 15 | 0301 | 3.01 | 2.31 | 65 | 81 |
| Example 16 | 0305 | 2.29 | 3.19 | 14 | 55 |
| Example 17 | 0310 | 1.18 | 4.19 | −21 | 30 |

### Examples 18-22

### Thermal Cure of DVBDO and Tone 0310 Polycaprolactone Triol with Increasing Excess Epoxide and Cycat 600 Catalyst

The procedure of Example 7 was repeated using 0.1 mL Cycat 600 as catalyst, DVBDO, and Tone 0310 polycaprolactone polyol (melted at about 60° C.) at various values of r. The formulation components were mixed at room temperature to give colorless solutions. The formulations were cured for 2 hr 100° C. to give tack-free solids having properties shown in Table VI.

TABLE VI
Thermal Cure of DVBDO and Tone 0310 Polycaprolactone
Triol with Increasing Excess Epoxide and Cycat 600 Catalyst

| | | DVBDO | Polyol | Tg | Shore A |
|---|---|---|---|---|---|
| Example | r | (g) | (g) | (° C.) | Hardness |
| Example 18 | 1.1 | 1.21 | 4.03 | −36 | 48 |
| Example 19 | 1.2 | 1.40 | 4.34 | −34 | 52 |
| Example 20 | 1.4 | 1.61 | 4.23 | −28 | 55 |
| Example 21 | 1.8 | 1.81 | 3.71 | −19 | 74 |
| Example 22 | 2.0 | 2.00 | 3.70 | −12 | 80 |

### Examples 23-25

### Thermal Cure of DVBDO and Terathane Polyols with Cycat 600 Catalyst

The procedure of Example 7 was repeated using 0.05 mL Cycat 600 as catalyst, DVBDO, and various Terathane polyols at r=1.6. The polyols were heated to about 60° C. to melt and/or reduce viscosity prior to combining with DVBDO. The formulation components were mixed at room temperature to give colorless solutions. The formulations were cured for 1 hr each at 60° C. and at 100° C. to give tack-free solids having properties shown in Table VII.

TABLE VII
Thermal Cure of DVBDO and Terathane Polyols with Cycat 600 Catalyst

| | Terathane | DVBDO | Polyol | Tg | Shore D |
|---|---|---|---|---|---|
| Example | Polyol | (g) | (g) | (° C.) | Hardness |
| Example 23 | 250 | 3.00 | 2.91 | 1 | 51 |
| Example 24 | 650 | 1.60 | 4.01 | −60 | 30 |
| Example 25 | 1000 | 1.21 | 4.63 | −69 | 10 |

### Examples 26-29

### Thermal Cure of DVBDO and Polycarbonate Polyols or Polyester Polyols with Cycat 600 Catalyst

The procedure of Example 7 was repeated using 0.1 mL Cycat 600 as catalyst, DVBDO, and various polyols at r=1.6. The polyols were heated to about 60° C. to melt and/or reduce viscosity prior to combining with DVBDO. The formulation components were mixed at room temperature to give colorless solutions. The formulations were cured for 1 hr each at 60° C. and at 100° C. to give tack-free solids having properties shown in Table VIII. Example 27 partially crystallized after standing at room temperature for 24 hr.

TABLE VIII
Thermal Cure of DVBDO and Polycarbonate Polyols or
Polyester Polyols with Cycat 600 Catalyst

| | | DVBDO | Polyol | Tg | Tₘ |
|---|---|---|---|---|---|
| Example | Polyol | (g) | (g) | (° C.) | (° C.) |
| Example 26 | PCPO 1000 | 1.62 | 6.18 | −32 | |
| Example 27 | PCPO 2000 | 0.99 | 7.72 | −40 | 45 |
| Example 28 | Fomrez 44-160 | 1.52 | 4.06 | −42 | |
| Example 29 | Fomrez 55-112 | 1.59 | 6.21 | −32 | |

### Examples 30-32

### Thermal Cure of DVBDO, Tone 0310 Polycaprolactone Triol, and 1,4-Butanediol with Cycat 600 Catalyst

The procedure of Example 7 was repeated using 0.1 mL Cycat 600 as catalyst, DVBDO, Tone 0310 polycaprolactone polyol (melted at about 60° C.)., and various amounts of 1,4-butanediol (BDO) with r=1.6. DVBDO and BDO alone formed an incompatible mixture. The formulation components were mixed at room temperature to give colorless solutions. The formulations were cured for 30 min each at 60° C., 100° C., and 150° C. to give tack-free solids having properties shown in Table IX.

TABLE IX
Thermal Cure of DVBDO, Tone 0310 Polycaprolactone Triol,
and 1,4-Butanediol with Cycat 600 Catalyst

| | DVBDO | Tone 0310 | BDO | Tg | Shore D |
|---|---|---|---|---|---|
| Example | (g) | (g) | (g) | (° C.) | Hardness |
| Example 30 | 1.94 | 4.02 | 0.08 | −28 | 24 |
| Example 31 | 2.16 | 3.99 | 0.16 | −27 | 24 |
| Example 32 | 2.49 | 4.00 | 0.26 | −23 | 24 |

### Examples 33-35

### Thermal Cure of DVBDO, Tone 0310 Polycaprolactone Triol, and Trimethylolpropane with Cycat 600 Catalyst

The procedure of Example 7 was repeated using 0.1 mL Cycat 600 as catalyst, DVBDO, Tone 0310 polycaprolactone polyol (melted at about 60° C.)., and various amounts of trimethylolpropane (TMP) with r=1.6. DVBDO and TMP alone formed an incompatible mixture. Mixtures of 10, 20 and 30 wt % TMP in Tone 0310 polyol were prepared at 60° C. and allowed to cool to room temperature to give colorless solutions. The polyol solution and DVBDO were then mixed at room temperature to give colorless solutions. The formulations were cured for 30 min each at 60° C., 100° C., and 150° C. to give tack-free solids having properties shown in Table X.

TABLE X
Thermal Cure of DVBDO, Tone 0310 Polycaprolactone Triol, and
Trimethylolpropane with Cycat 600 Catalyst

| | | | Polyol | | |
|---|---|---|---|---|---|
| | DVBDO | % TMP in | Solution | Tg | Shore D |
| Example | (g) | Polyol | (g) | (° C.) | Hardness |
| Example 33 | 1.70 | 10 | 2.49 | −10 | 40 |
| Example 34 | 2.31 | 20 | 2.49 | 24 | 75 |
| Example 35 | 2.96 | 30 | 2.52 | 58 | 75 |

### Example 36

### Thermal Cure of DVBDO, Tone 0310 Polycaprolactone Triol, and Glycerol with Cycat 600 Catalyst

The procedure of Example 7 was repeated using 0.1 mL Cycat 600 as catalyst, DVBDO, Tone 0310 polycaprolactone polyol (melted at about 60° C.)., and glycerol (GLY) with r=1.6. DVBDO and GLY alone formed an incompatible mixture. Mixtures of 10 wt %, 20 wt %, and 30 wt % GLY in Tone 0310 polyol were prepared at room temperature to give colorless solutions. The 10% polyol solution and DVBDO were then mixed at room temperature (20-25° C.) to give a colorless solution, whereas the 20% and 30% polyol solutions were incompatible with DVBDO. The 10% formulation was cured for 30 min each at 60° C., 100° C., and 150° C. to give a tack-free solid having a Tg of −18° C. and a Shore D hardness of 30.

### Example 37

### Thermal Cure of DVBDO and Polyethylene Glycol with Cycat 600 Catalyst

The procedure of Example 7 was repeated using 3.01 g DVBDO, 2.32 g polyethylene glycol (Mₙ=200), and 0.1 mL Cycat 600 as catalyst with r=1.6. The formulation components were mixed at room temperature to give a colorless solution which was cured for 1 hr each at 60° C. and 100° C. to give a tack-free solid having a Tg of 2° C. and a Shore D hardness of 54.

### Examples 38-40

### Ambient and Thermal Cure of DVBDO and Dipropylene Glycol with Cycat 600 Catalyst

The procedure of Example 7 was repeated using DVBDO, varying amounts of dipropylene glycol (DPG), and 0.1 mL Cycat 600 as catalyst. After mixing into the DVBDO-polyol solution the formulation was poured into an Al dish and allowed to stand at room temperature for 4 days to give a tack-free solid. Portions of Examples 39 and 40 were post-cured by heating to 200° C. The formulations and cured properties are shown in Table XI.

TABLE XI
Ambient and Thermal Cure of DVBDO and Dipropylene
Glycol with Cycat 600 Catalyst

| | | DVBDO | DPG | T_{g}-Ambient | T_{g}-Thermal |
|---|---|---|---|---|---|
| Example | r | (g) | (g) | (° C.) | (° C.) |
| Example 38 | 1.5 | 1.62 | 0.89 | 4 | — |
| Example 39 | 1.8 | 1.62 | 0.74 | 38 | 112 |
| Example 40 | 2.0 | 1.61 | 0.66 | 43 | 98 |

### Example 41

### Ambient Cure of DVBDO and Voranol 225 Polyol with H₂SO₄ Catalyst

The procedure of Example 7 was repeated using 0.1 mL conc. H₂SO₄ as the added compound. After mixing into the DVBDO-polyol solution the formulation was poured into an Al dish and allowed to stand at room temperature for 18 hr to give tack-free solid having Tg of 14° C. and a Shore A hardness of 75.

### Example 42

### Ambient Cure of DVBDO and 1,2-Propylene Glycol with Al₂(SO₄)₃ Catalyst

A solution of 0.5 wt % Al₂(SO₄)₃.6H₂O in 1,2-propylene glycol (PG) was prepared. To a 20 mL vial were added 4.0 g DVBDO and 1.0 g of the above PG solution (r=1.6) and mixed to form a colorless solution. The formulation was poured into an Al dish and allowed to stand at room temperature for 18 hr to give tack-free solid having Tg of 50° C. and a Shore A hardness of 84.

### Examples 43-57

### Thermal Cure of DVBDO and 1,2-Propylene Glycol with Various Catalysts

Solutions or suspensions of various catalysts were prepared at 5 wt % in 1,2-propylene glycol, except for Example 52 which was prepared at 0.5 wt %. The acid-activated Al(O-t-Bu)₃ catalysts were prepared using the indicated concentrated acid at 5 wt %. The procedure of Example 7 was repeated using 4.0 g. DVBDO and 1.0 g catalyst solution (r=1.6 and 1 wt % catalyst or in Example 520.1 wt %) and the formulations were cured for 30 min each at 60° C. and 100° C. and then for 2 hr at 150° C. to give tack-free solids having Tg values shown in Table XII.

TABLE XII
Thermal Cure of DVBDO and Dipropylene
Glycol with Various Catalysts

| | | Tg |
|---|---|---|
| Example | Catalyst | (° C) |
| Example 43 | Cycat 600 | 63 |
| Example 44 | SbBr₃ | 78 |
| Example 45 | Sb(OAc)₃ | 60 |
| Example 46 | Supercat XK-614 | 57 |
| Example 47 | SnCl₂ | 80 |
| Example 48 | SnCl₄ | 80 |
| Example 49 | H₃PO₄ | 129 |
| Example 50 | Sn(octoate)₂ | 53 |
| Example 51 | FeCl₃ | 91 |
| Example 52 | Sb(SF₆)₃ | 53 |
| Example 53 | Cu(BF₃)₂ | 55 |
| Example 54 | AlCl₃•6H₂O | 82 |
| Example 55 | Al(O-t-Bu)₃-HCl | 67 |
| Example 56 | Al(O-t-Bu)₃-HOAc | 50 |
| Example 57 | Al(NO₃)₃ | 48 |

### Examples 58-61

### Cure of DVBDO, Fomrez 55-225 Polyester Polyol, and Assorted Catalysts

The required quantity of catalyst (1 wt % with respect to the reactants) was weighed, and to it was added the polyol and DVBDO. The samples were mixed in a high speed mixer for 30 seconds (s) at 2350 revolutions per minute (rpm). The samples were then subjected to different temperatures to cure the formulations into solids having Tg values shown in Table XIII.

TABLE XIII
Cure of DVBDO, Fomrez 55-225 Polyester Polyol,
and Assorted Catalysts

| | | Cure | Cure | |
|---|---|---|---|---|
| | | Time | Temperature | Tg |
| Example | Catalyst | (hr) | (° C.) | (° C.) |
| Example 58 | EMA | 24 | 100 | −19 |
| Example 59 | Mo(II) octoate | 24 | 100 | −45 |
| Example 60 | UL-28 | 2, 12 | 100, 150 | −34 |
| Example 61 | Snapcure 2130 | 18 | 150 | |

It will be obvious to persons skilled in the art that certain changes may be made in the methods described above without departing from the scope of the present invention. It is therefore intended that all matter herein disclosed be interpreted as illustrative only and not as limiting the scope of protection sought. Moreover, the process of the present invention is not to be limited by the specific examples set forth above including the tables to which they refer. Rather, these examples and the tables they refer to are illustrative of the process of the present invention.

1. A curable composition comprising (a) at least one divinylarene dioxide; (b) at least one polyol; and (c) at least one cure catalyst, said cure catalyst being effective in catalyzing the reaction between the divinylarene dioxide and the polyol and being active at greater than or equal to ambient temperature, wherein the curable composition is a compatible mixture.

2. The composition of claim 1, wherein the at least one divinylarene dioxide comprises divinylbenzene dioxide.

3. The composition of claim 1, wherein the at least one polyol comprises a diol, a glycol, a triol, a tetrol, a pentol, a hexyl, a polyether polyol, a polyester polyol, a polycarbonate polyol, a polyalkylidine polyol, or mixtures thereof.

4. The composition of claim 1, wherein the at least one cure catalyst comprises a Bronsted acid, a Lewis acid, a main group or transition metal complex, an imidazolium salt, or mixtures thereof.

5. The composition of claim 1, wherein the percent opacity is less than 90.

6. The composition of claim 1, including a filler, a reactive diluent, a flexibilizing agent, a processing aide, a toughening agent, or a mixture thereof.

7. The composition of claim 1, wherein the cure catalyst cure the curable composition at a temperature of from −50 to 200° C.

8. A process for preparing a curable composition comprising admixing (a) at least one divinylarene dioxide; (b) at least one polyol; and (c) at least one cure catalyst, said cure catalyst being effective in catalyzing the reaction between the divinylarene dioxide and the polyol and being active at ambient and higher temperatures, wherein the curable composition is a compatible mixture.

9. A process for preparing a cured composition comprising curing the composition of claim 1.

10. A cured article prepared by the process of claim 9.
